(19) United States
(12) Patent Application Publication
(10) Pub. No.: US 2017/0024537 A1
(43) Pub. Date: Jan. 26, 2017

(54) MOBILE TELEMEDICINE UNIT

(71) Applicant: MAXIMUS SECURITY, LLC, St. Clair, MI (US)

(72) Inventor: Frank J. Ferlito, St. Clair, MI (US)

(21) Appl. No.: 15/218,647

(22) Filed: Jul. 25, 2016

Related U.S. Application Data
(60) Provisional application No. 62/196,696, filed on Jul. 24, 2015.

(51) Int. Cl. G06F 19/00; H04L 9/06; H04L 29/06

(52) U.S. Cl. CPC G06F 19/3418; H04L 63/0853; H04L 9/0631

(57) ABSTRACT

A mobile telemedicine unit having a high gain antenna, and mobile modem with a web or client based feature to run over variable bandwidths to connect, stay connected, or auto-reconnect a telemedicine session through a hosted or cloud-based solution. The unit is lightweight, is self-contained with a power source and a wireless signal, and is able to be carried directly to a patient's location or permanently wired in an ambulance. The modem also includes multiple cellular carriers' subscriber identity module cards to improve signal strength. The unit has at least one camera and/or medical diagnostic device that is operated by a medical professional in the patient's presence. This is streamed live over a cellular or satellite signal to a healthcare provider who is able to see, interview and potentially diagnose the patient in real time, remotely.

### CROSS-REFERENCE TO RELATED APPLICATIONS

This application claims the benefit of U.S. Provisional Application No. 62/196,696, filed Jul. 24, 2015. The disclosure of the above application is incorporated herein by reference.

### FIELD OF THE INVENTION

The present invention relates to a portable telemedicine device and method to provide emergency services, diagnostic care or other healthcare to individuals.

### BACKGROUND OF THE INVENTION

Paramedicine for providing emergency medical care uses several methods of communication and administration of care for a person in need that are known in the art. Currently, individuals trained in paramedicine such as paramedics and emergency medical technicians communicate with doctors, specialists, nurses, or other emergency hospital personnel by a number of known methods from the scene of an emergency and/or while in the ambulance in route to the hospital. One such communication method is by handheld radio. Another is by calling a designated line to the hospital using a cellular phone kept in the ambulance, which conversation is typically recorded. Through either method the emergency responder is able to communicate with the response staff at the hospital to provide situation reports and receive feedback. For example, an emergency physician could give the first responder verbal permission to administer particular medications over the phone based on information the first responder is providing to the doctor. Such methods rely on verbal communication alone and provide no patient visual or visual interaction with the physician or other staff at the hospital.

Telemetry is another known communications process which generally includes measuring patient data and transmitting the data to the hospital. For example, a first responder places 12 leads on a patient to take an electrocardiogram (EKG) while at the scene of the emergency and/or while in route in the ambulance to the hospital. The first responder can review the EKG on the spot, but telemetry also wirelessly sends that EKG information directly to the hospital where an emergency physician can analyze a printed off copy of the EKG before the patient arrives. Telemetry allows more accurate and quicker findings by the physician of potential conditions such as a heart attack so that medications or other treatment protocols can be administered as quickly as possible by the first responder under the physician's orders and/or so emergency physicians and other healthcare professionals can be better prepared for the patient's arrival. However, such a method relies primarily on verbal communication, after the telemetry transmission, between the doctor and first responder for administration of verbally approved care, and still provides no patient visual and visual interaction for the physician or other staff located at the hospital for preliminary diagnosis and pre-hospital care.

Telemedicine is a generally known telecommunication providing remote medical services. Generally, healthcare professionals can communicate with patients and other healthcare professionals from different locations, in particular, for remote patient monitoring. For example, paramedicine professionals, nurses or other healthcare staff can travel to a patient's residence after release from the hospital to check on whether the discharge papers are being followed, e.g., taking medications, blood pressure monitored, etc, and the results communicated to their doctor. Other known methods include video consults from patient homes, patients traveling to remote centers to interact with doctors at other locations for care, and/or doctors at multiple locations collaborating on patient care, e.g., doctors simultaneous viewing neonatal chest x-rays from one location electronically transferred to one or more other locations within the hospital or to more than one hospital.

All of the aforementioned systems fail to provide live access allowing real-time audio and video during emergency services involving first responders.

Therefore, there remains a need for a system that provides interactive mobile telemedicine sessions at the patient's location allowing a healthcare provider to view, interview and potentially diagnose the patient in real-time, remotely, using any of a multiple of diagnostic devices, as needed.

### SUMMARY OF THE INVENTION

There is provided a mobile telemedicine system for use by medical professionals to diagnose and treat patients remotely. A healthcare provider (e.g., emergency physician) is able to interview and potentially diagnose the patient in real time, remotely, utilizing one or more of a multitude of medical diagnostic devices (e.g., stethoscope, ECG, otoscope, general examination, ultrasound, etc) and/or at least one camera (e.g., fixed camera(s) and/or handheld camera(s), etc) that is/are selectively operated by at least one other medical professional (e.g., nurse, paramedic, EMT, etc) that is in the patient's presence and under the direct supervision of the physician at another location who is in constant supervisory control of the situation.

The mobile telemedicine system generally combines a high gain antenna, and mobile modem with a web or client based software designed to run over variable bandwidths down to a 2G signal, 36 kbps. This combination enables the system to connect, stay connected, or auto-reconnect the telemedicine session through a hosted or cloud-based solution. Preferably, the system is lightweight, is self-contained with power and a wireless signal, and is able to be carried directly to a patient's location or permanently wired in an ambulance.

A preferred embodiment of the mobile telemedicine system includes a computer system having two or more computing devices, a high gain multidirectional antenna, a mobile modem or bonded modem, a plurality of cameras, and a plurality of medical diagnostic devices at the patient's location. The bonded modem includes multiple cellular carriers' subscriber identity module (SIM) cards suitable to improve signal strength (e.g., AT&T™, Verizon™, T-Mobile™, Sprint™, and/or U.S. Cellular™ and any other carriers depending on the particular application). A particular preferred cellular for use in the present invention is Verizon™ Wireless. The patient's information is streamed live over a cellular or satellite signal to a healthcare provider (i.e. physician, physician's assistant, nurse or the like) with the minimum of a Health Insurance Portability and Accountability Act (HIPPA) compliant AES-128 bit encrypted transmission or other suitable compliant advanced encryption standard. The healthcare provider is then able to interview the patient or first responders and potentially diagnose the patient in real time.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is front elevation view of a mobile telemedicine unit, according to an embodiment of the present invention;

FIG. 2 is a perspective view of a monitor and two cameras of the mobile telemedicine unit in an exemplary environment of use, in accordance with the present invention;

FIG. 3 is a perspective view of one of the cameras of the mobile telemedicine unit, in accordance with the present invention;

FIG. 4 is a perspective view of another camera of the mobile telemedicine unit, in accordance with the present invention;

FIG. 5 is a perspective view of the mobile telemedicine system in accordance with an embodiment of the present invention; and

FIG. 6 is a schematic diagram illustrating an exemplary mobile telemedicine system environment that may be used to implement certain embodiments of the invention.

### DETAILED DESCRIPTION OF THE PREFERRED EMBODIMENTS

The following description of the preferred embodiment(s) is merely exemplary in nature and is in no way intended to limit the invention, its application, or uses.

In accordance with the present invention, a mobile telemedicine system is provided for ambulances, medics, fire/rescue, police and other first responders, and wherever there is a mobile need for recorded and live access video and audio. In addition, when a 4G long-term evolution (LTE) network connection, for example, is activated a modem provides GPS real-time tracking and mapping when desired. The telemedicine system according to the present invention for pre-hospital diagnosis and care is the latest in advanced mobile telemedicine technology for ambulances, etc. Originally designed for pediatric/neonatal emergency transportation it is adaptable and ideal for any emergency transportation services or other medical services. This sophisticated, yet simple to use system provides live access from high quality IP cameras (e.g., webcam) using a touch screen interfaced CPU of the computing device. When an emergency call is initiated from an ambulance or other location of patient care or the hospital, the cameras are activated, e.g., automatically or by touch screen selection, and can be viewed live to help paramedics and emergency physicians treat patients in critical need of life saving procedures. Not only is this a live access system allowing real-time audio and video, but sessions are also recordable for quality, documentation, training and compliance purposes. The system is HIPAA compliant, provides the highest level of security in the public domain (AES256 or any other suitable protocol for securing data/transmissions), and remains connected even in the most rural areas as it can generally function properly no matter the signal or service (typically, from a 2G signal on up through 4G LTE service, preferably, from 2G through at least 4G LTE). 2G through 5G or more is contemplated without departing from the scope of the present invention. Preferably, communications/information/etc are operably compressed to run over low bandwidths, most preferably, automatically compressed, e.g., employing software, low bandwidth software, etc. suitable for automatic compression for transmission.

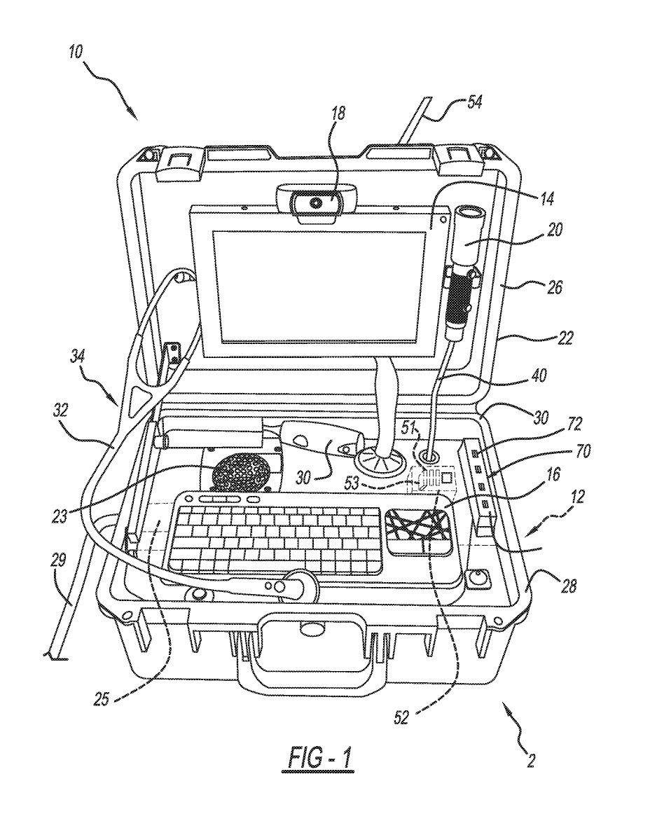

Referring to FIGS. 1-6 generally, there is provided a mobile telemedicine system shown generally at 2 that includes at least one mobile telemedicine unit shown generally at 10 having at least one computing device generally shown at 12, e.g., with a monitor 14 and a keyboard 16, and at least one camera. A first camera 18 is operably mounted to or otherwise incorporated with the monitor 14. Most preferably, the first camera 18 is a webcam. A second camera 20 is operably connected to the computing device 12. Most preferably, the second camera 20 is a handheld camera that is movable to selectively provide different views such as close ups of the patient or diagnostic equipment. While two cameras are shown, it is understood that more or less than two cameras can be provided depending on the particular application without departing from the scope of the present invention.

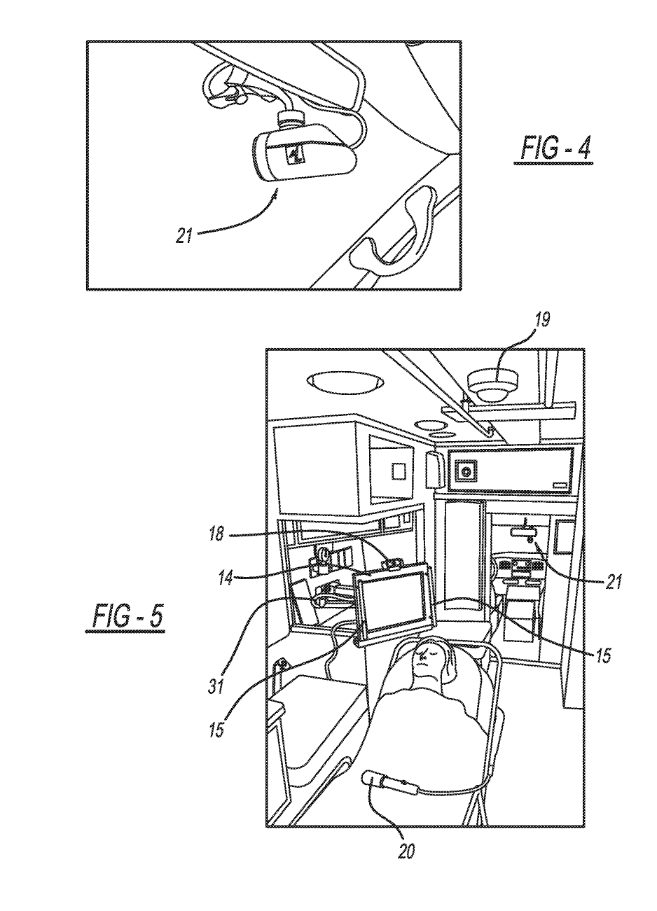

Optionally, a third camera 19 (see FIG. 5) is provided for another predetermined view, preferably, an overhead camera providing a 360 degree view of the interior of the ambulance. Optionally, at least one headset providing an audio transmitter and/or live view is provided. Optionally, a fourth camera 21 (see FIG. 4) is provided for yet another predetermined view, preferably, a dash camera mounted to the windshield interior to providing a street view of the mechanism of injury and/or ambulance transport route, etc).

The computing device 12 is preferably a rugged personal computer (PC) that is fan-less and vibration and shock rated. The unit 10 generally includes at least one high quality integrated loud speaker or microphone 23. At least one microphone 23 is provided, preferably, voice adjusting noise cancelling microphone(s), most preferably, omnidirectional condenser microphone.

The keyboard 16 is preferably a wireless keyboard.

The monitor 14 is preferably a touch screen monitor, most preferably, a resistive touch LCD monitor. Most preferably, a projected capacitive touch screen monitor that is shock and vibration resistant. The touch screen for example can include a menu with hospital(s) and/or department(s). Touching the selection, e.g., particular hospital, from the menu causes the unit to dial directly to the hospital. The first camera 18 is removably or fixedly mountable on any portion of the monitor 14 or incorporated with the monitor. In a preferred embodiment the first camera 18 is a web camera, most preferably, a live streaming high definition (HD) webcam, which can be operably mounted to the monitor using a mounting bracket 24. Optionally, two opposing handles, e.g., stainless steel handles 15 (see FIG. 5), are operably connected to the sides of the monitor 14 to grasp for moving the monitor 14 into desired locations.

The second camera 20 is preferably a rugged HD examination camera with a light source. Most preferably, a rugged handheld real-time HD (e.g., 720p) exam camera with LED light and photo snap shot capability. This is a significant camera 20 housed in a rugged water resistant aluminum grip 36. The second camera 20 provides paramedics the capability to stream live video to physicians at a hospital with precise, up-close views of specific areas of immediate concern. The second camera 20 is also equipped with two buttons: a first button 38 is for a bright LED light, which provides a brighter non shadow view of eyes, ears, mouth, throat, and etc. A second button 39 is a snapshot function. With a press of this button, a Jpeg picture is taken and stored, which can later be used for further diagnosis, documentation and to be included in the patient's medical file or paramedic report.

In one embodiment the mobile telemedicine unit 10 has a casing 22 or housing, such as a hinged clam shell type case, to provide portability. The casing 22 typically has a first half 26 (e.g., upper half) and a second half 28 (e.g., lower half with at least one compartment). Most preferably, the casing 22 is a compact, rugged, water resistant and dustproof case. Optionally, protective padding, netting, straps, snap fit clips, foam, and/or integrally formed features are located within the interior of the case to cradle or nest the components within the case further preventing undesired movement and damage during transport and use. Optionally, the casing 22 is operably adapted with at least one fixed or rotatable handle, retractable handle, and/or wheels or any other suitable durable conveyance feature to make handling easier. At least one latch and/or locking mechanism secures the casing 22 when in the closed position.

The mobile telemedicine unit 10 also includes at least one antenna, preferably, a band covert antenna, most preferably, a multiband, hi-gain antenna. At least one modem 52 is provided. A 4G/LTE gateway (WIFI and GPS enabled) modem is typically also provided, as will be explained in greater detail below. The modem 52 includes a plurality of slots 51 for loading a plurality of SIM cards 53 (e.g., SIM cards for a plurality of cellular carriers). Generally, each modem 52 includes at least one antenna 54 incorporated into the modem 52 and/or externally mounted in a suitable predetermined location. The modem 52 is mountable within either the first or second half 26,28 of the casing 22, and, alternatively, operably connected to an outer surface of the casing 22 or remotely and plugged in. Most preferably, the modem 52 is concealed within the second half 28. The antenna 54 is operably mountable within either the first or second half 26,28 of the casing 22, alternatively, operably connected to an outer surface of the casing 22 or remotely. Optionally, the system includes at least one range extender, booster, router, and/or any other devices suitable for improved signal strength are provided.

The monitor 14 is operably mounted within the first half 26 of the casing 22 such that the monitor 14 remains in the casing 22 during use by a first responder, when desired, additionally such that the monitor 14 is quickly selectively removable from the casing 22 when desired. The keyboard 16 is operably mounted within the second half 28 of the casing 22, preferably, additionally such that the keyboard 16 is quickly selectively removable from the casing 22 when desired. The first and second half 26, 28 are operably adapted such that the casing 22 helps prevent tipping during use in the open position. The mobile telemedicine unit 10 components are contained within a durable carrying case, typically, measuring about 22 inches×18 inches×9 inches. This portable, easy to carry, system has all the equipment included in the hardwired vehicle system described above and further below, except for the optional overhead camera or dash cam. A first responder simply opens the rugged, water-proof case and plugs in the 12V DC power cord 29 to establish a mobile medical station. Preferably, the unit 10 is powered by either a 12V power cord plugged into the vehicle's supplied power outlet or into a 110V standard power plug. Alternatively, the system is a hardwired 31 vehicle system. According to an embodiment of the present invention, the unit 10 includes rechargeable battery power 25 within the casing 22.

The mobile telemedicine unit 10 further includes a plurality of medical diagnosis devices indicated generally at 34. Preferably, at least an otoscope 30 and a stethoscope 32. At least one universal serial (USB) hub 70 with a plurality of ports 72 is provided. The medical diagnosis devices 32 are selectively plugged into the ports 72. The USB hub 70 is mountable to either the first or second half 26,28 of the casing 22, preferably, to the second half 28 operably readily accessible for plugging in any peripheral devices. Preferably, the otoscope 30 is a wireless digital otoscope. Preferably, the stethoscope 32 is a wireless electronic stethoscope 32. Most preferably, a wireless, digital video otoscope with internal light and photo snap shot capability. Alternative and/or additional medical diagnosis devices can be incorporated including, but not limited, to an ECG device, ultrasound device, etc., depending on the particular application.

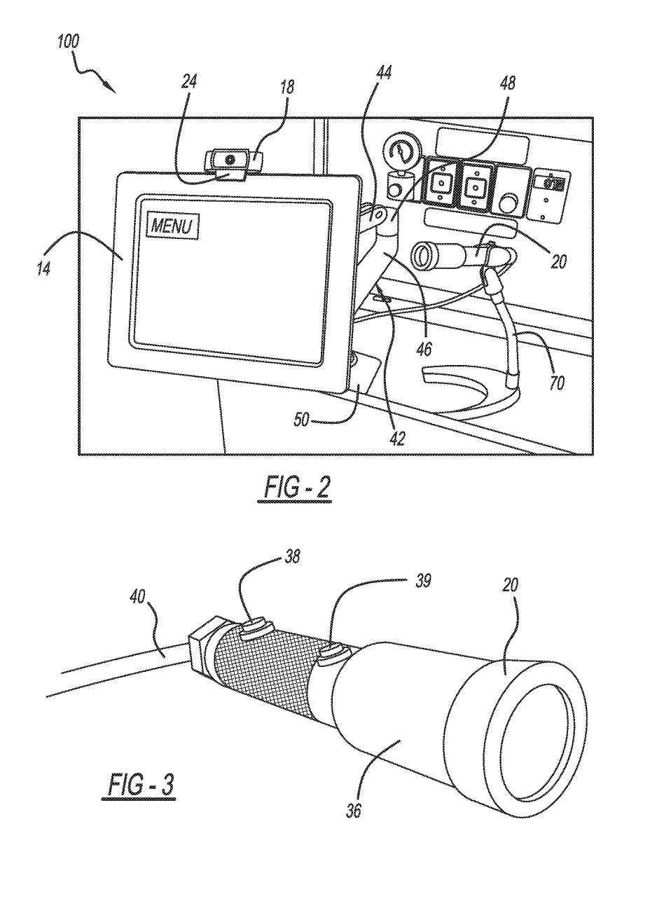

In another embodiment, the mobile telemedicine unit is operably mounted within the interior of a first responder vehicle or at a stationary location, as will be explained in greater detail below. Referring more particularly to FIG. 2, wherein like numbers indicate like parts, the mobile telemedicine unit shown generally at 100 is operably mounted, e.g., fixed in place within the interior of the ambulance—ground or air ambulance. In one embodiment a casing 22 is not provided. Alternatively, the unit 10 is removed from the casing 22 and releasably operably mounted. Alternatively, the unit 10 is plugged into the vehicle outlet. In one embodiment, the unit 10 is hardwired within the vehicle. In one embodiment, only portions of the unit 10, e.g., monitor 14 and keyboard 16, are removed and mounted to the vehicle or otherwise used outside of the casing 22.

Preferably, a linkage assembly indicated generally at 42 is provided, including at least a first link 44 and a second link 46 rotatable mounted at joint 48. The first link 44 is operably connected to the monitor 14 and the second link 46 is operably connected to a base 50 adapted for operably mounting to a surface within the ambulance. It is contemplated that other mounting arrangements and locations can be used depending on the particular application. The second camera 20 is releasably mounted to a stand 70.

Referring more particularly to FIG. 5, in one embodiment, at least three unique cameras are included in the mobile telemedicine system 2, one of which is the third camera 19, most preferably, a high quality multi view IP camera providing a 360°, 180° or panoramic overhead view of the interior of the ambulance. Physicians viewing these camera images will have a clear overall image of what is taking place inside the ambulance. Another camera in the system is the first camera 18, most preferably, a top quality webcam attached to the touch screen monitor. This camera provides physicians a face to face view with the paramedics and another perspective of the patient. Another camera is the second camera 20, most preferably, a handheld camera. A wire 40 connects the second camera 20 to the computing device 12. Wireless is contemplated. In a preferred embodiment, the fourth camera 21 is also provided, preferably, a dash camera mounted near the windshield to provide a street view of the mechanism of injury or ambulance transport route. All of the cameras allow live streaming access by remote physicians for numerous views of the patient and transport. Maintaining real-time audio and video, in combination with being simultaneously recordable, is a significant benefit to patient diagnosis and care.

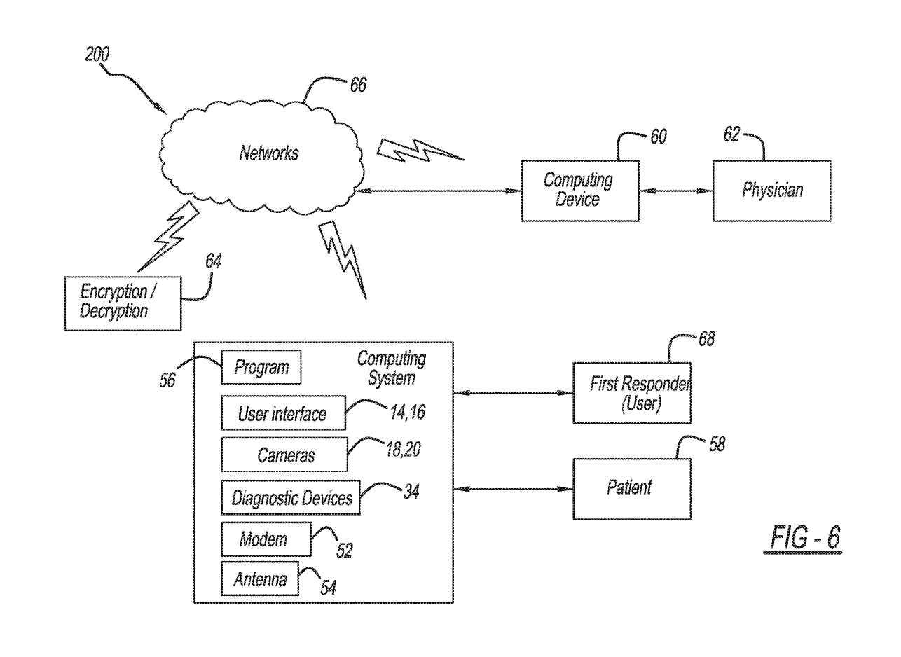

Referring to FIG. 6 generally, a schematic block diagram illustrating an exemplary telemedicine network environment, generally shown at 200, in which certain embodiments of the invention can be implemented, and including a computer system that may be used to implement certain embodiments. There is provided a computer system including user interface, e.g., at least the monitor and keyboard 14, 16, an antenna 54, a modem 52, a program 56, at least the first and second cameras 18, 20, and medical diagnostic devices 34 at the patient's 58 location. At least one computing device 60 at the physician's 62 location is provided. The hospital/physician 62 has control of what they want to view real-time from their remote location. Thus, as the first responder 68 interacts with the patient 58 and operates the cameras, diagnostic devices and/or user interface in the patient's 58 presence, this interaction is able to be supervised by the physician 62 who is also able to interview and potentially preliminarily diagnose the patient 58 in real-time, remotely.

The program 56 also assists with HIPPA compliance providing security encryption/decryption generally indicated at 64, e.g., AES-256, or any other desired encryption software. The network 66 connection is maintainable even in the most rural areas, without dropped calls or redialing to connect. The system can also transmit and receive on a cellular signal, at least as low as 36 KPS, a low resolution video—5 FPS with audio.

This is live access system and preferably requires a mobile broadband 4G/LTE wireless connection. No additional hardware is therefore required in accordance with a preferred embodiment.

Referring to the Figures generally, this system is unique in the way it combines a high gain antenna, and mobile modem with a web or client based software designed to run over variable bandwidths down to a 2G signal, 36 kbps. The combination enables the system to connect, stay connected, or auto-reconnect the telemedicine session through a hosted or cloud-based solution. This system can be lightweight, self-contained with power and a wireless signal, able to be carried directly to a patient's location or permanently wired in an ambulance. The system includes a computer system, a high gain multidirectional antenna, a mobile modem or bonded modem, cameras, and medical diagnostic devices at the patient's location. The bonded modem includes multiple cellular carriers' SIM cards to improve signal strength. The patient's information is streamed live over a cellular or satellite signal to a healthcare provider (i.e. physician, physician's assistant, nurse or the like) with the minimum of a HIPPA compliant AES128 bit encrypted transmission. The healthcare provider is then able to interview and potentially diagnose the patient in real time, remotely, utilizing a multitude of medical diagnostic devices stethoscope, ECG, otoscope, general general examination, camera, ultrasound, etc) and cameras operated by one or more other medical professionals (nurse, paramedic, EMT) that is in the patient's presence and under the direct supervision of the physician another location who is in constant supervisory control of the situation. The modem for example generally has a WIFI signal about 300 feet away.

The system is preferably a bonded system—machine to machine. The modem is preferably a smart modem, bonded system. The system preferably eliminates having to reboot and eliminates storing data on board. The system also allows medical professionals to hear and/or see peripherals.

Depending on the application, it is contemplated that the invention is adaptable for live access allowing real-time audio and video, that is also recordable, between first responders and one or more of at least their central command post, e.g., station dispatch, city general dispatch, county central dispatch center, etc and/or any combination thereof, alone and/or in combination with one or more hospitals, etc.

It is further contemplated that the invention is adaptable for more than just first responders depending on the application. By way of non-limiting example any healthcare provider or medical professional (e.g., traveling nurses, hospice and palliative care providers, mental health professionals, physical therapists), paramedics, firefighters, police officers, patients, recovering cardiac patients, businesses/industries (such as those that would also have a defibrillator, e.g., sport/concert venues, retirement homes, etc), extreme or remote and/or large capacity events, mobile magnetic resonance imaging (MRI) units, medical clinics and etc, or wherever a mobile system is desired.

It is understood that the terms “computer” and “computing device”, e.g., the hospital or physicians computer 60 and/or first responders 68 computer can include any type of device including, but not limited to, personal computers, laptop computers, handheld or portable devices such as smartphones, e.g., IPhones™, Droid™, BlackBerry™, Nokia™, and HTC™, mobile phones, notebooks, tablet PCs, all-in-one touch screen PCs, Ipads™ and any other computing device of any kind are all contemplated. The physician for example could be on-call and use a smartphone to remotely communicate with medical professionals and/or the patient or first responders before the physician even arrives to the emergency room.

The description of the invention is merely exemplary in nature and, thus, variations that do not depart from the essence of the invention are intended to be within the scope of the invention. Such variations are not to be regarded as a departure from the spirit and scope of the invention.

What is claimed is:

1. A telemedicine system, comprising:
at least one first computing device;
at least one camera;
at least one medical diagnostic device;
at least one antenna;
at least one modem, the antenna and modem operable to connect wirelessly to stream live over a cellular or satellite signal to at least one other computing device to allow live streaming of video, audio and/or of the at least one medical diagnostic device from a remote location.

2. The telemedicine system of claim 1, further comprising a plurality of multiple cellular carriers' subscriber identity module (SIM) cards, wherein the modem is a bonded modem including the SIM cards operably connected to the modem to improve signal strength.

3. The telemedicine system of claim 1, further comprising a casing for portability of the unit.

4. The telemedicine system of claim 1, further comprising a linkage assembly for mounting at least a monitor of the telemedicine unit to a vehicle and a stand for selectively holding the at least one camera of the telemedicine unit.

5. The telemedicine system of claim 1, wherein the at least one camera is a plurality of cameras, the plurality of cameras comprising:
at least one first camera that is a web camera;
at least one second camera that is a handheld camera that includes light-emitting diode and photo snap shot capability; and
optionally, at least one third camera that is a multi-view overhead camera, and/or, at least one fourth camera that is a dash camera.

6. The telemedicine system of claim 5, wherein the handheld camera is a high definition internet protocol camera housed in a water resistant aluminum grip.

7. The telemedicine system of claim 1, further comprising selective encryption/decryption for secure communication between the computing devices.

8. The telemedicine system of claim 7, wherein the encryption protocol is AES-128 bit for encrypted transmission.

9. The telemedicine system of claim 1, wherein the modem is a mobile modem with a web or client based system operable to run over variable bandwidths down to a 2G signal, 36 kbps.

10. The telemedicine system of claim 1, wherein the telemedicine system supports from a 2G signal through at least a 4G LTE service.

11. The telemedicine system of claim 1, wherein the antenna is a multiband, hi-gain antenna.

12. The telemedicine system of claim 1, wherein the telemedicine system is a live access system and provides a mobile broadband 4G/LTE wireless connection.

13. The telemedicine system of claim 12, wherein when the 4G/LTE network connection is operably activated, the modem provides Global Positioning System (GPS) real-time tracking and mapping, when desired.

14. The telemedicine system of claim 1, further comprising a 12 volt DC power cord for selectively plugging into a power source to establish a mobile medical station.

15. The telemedicine system of claim 14, further comprising a lightweight casing, wherein the telemedicine system is self-contained with a power source/charge and a wireless signal, allowing the system to be carried directly to a patient's location.

16. The telemedicine system of claim 1, further comprising predetermined wiring, wherein the telemedicine system is permanently operably wired in an ambulance, fire truck, police vehicle, boat, helicopter or any other first responder vehicle or watercraft.

17. The telemedicine system of claim 1, wherein the antenna is a high gain multidirectional antenna and the modem is a mobile modem or bonded modem that is web or client based to run over variable bandwidths down to at least a 2G signal and up to at least 4G LTE, wherein the combination of antenna and mobile modem enables the unit to connect, stay connected, or auto-reconnect a telemedicine session through a hosted or cloud-based solution.

18. The telemedicine system of claim 1, further comprising a touch screen interfaced computing system for activation of real-time audio and video within an emergency vehicle during a telemedicine session, and, optionally, activating recording of the telemedicine session.

19. A mobile telemedicine unit, comprising:
at least one computing device having a first camera, said first camera being a web camera for viewing a patient;
at least one second camera, said second camera being a handheld camera for close-up views of the patient;
at least one medical diagnostic device, said at least one medical diagnostic device selected from the group consisting of stethoscope, electrocardiogram, EKG, otoscope, microphone, ultrasound and combinations thereof;
at least one speaker and/or microphone;
at least one antenna;
at least one modem including a plurality of multiple cellular carriers' subscriber identity module (SIM) cards, the antenna and modem operably connectable wirelessly to stream live over a cellular or satellite signal to another computing device of a user directing care of the remotely located patient, wherein the live stream includes video, audio and/or medical diagnostic device readings; and
a casing to transport the mobile telemedicine unit;

20. A mobile telemedicine system for emergency care, comprising:
at least one first computing device including a touch screen monitor and/or a wireless keyboard;
at least one second computing device;
a hosted or cloud-based service;
at least one antenna;
at least one modem, the antenna and modem connecting wirelessly to stream live over a cellular or satellite signal to a first medical professional that is not in the presence of a patient;
at least one camera, wherein said at least one camera is a web camera handheld camera, 360 degree view overhead camera, 180 degree view overhead camera, panoramic overhead camera, and/or a dash camera;
at least one medical diagnostic device, wherein the at least one camera and at least one medical device operated by another medical professional in the patient's presence allowing the first medical professional to see and potentially diagnose the patient in real time, remotely.
